(19) United States
(12) Patent Application Publication
(10) Pub. No.: US 2008/0252922 A1
(43) Pub. Date: Oct. 16, 2008

(54) IMAGE-DATA MANAGEMENT SYSTEM, NETWORK SCANNER DEVICE, AND IMAGE-DATA MANAGEMENT METHOD

(75) Inventors: Kosuke Ikegami, Ishikawa (JP); Akihisa Kozakura, Ishikawa (JP)

Correspondence Address: LOWE HAUPTMAN HAM & BERNER, LLP, 1700 DIAGONAL ROAD, SUITE 300, ALEXANDRIA, VA, 22314, US

(73) Assignee: PFU LIMITED, ISHIKAWA (JP)

(21) Appl. No.: 12/031,435

(22) Filed: Feb. 14, 2008

(30) Foreign Application Priority Data
Apr. 13, 2007 (JP) 2007-106491

(51) Int. Cl. G06K 15/00

(52) U.S. Cl. 358/1.15

(57) ABSTRACT

An image-data management system that includes an authentication server device and a network scanner connected to each other via a network, wherein the network scanner device includes a keyboard, a display, a control unit, and a storage unit, the keyboard and the display are disposed so as to cover the top of the body of the network scanner device. The control unit includes a user-authentication requesting unit that sends a user ID and password to the authentication server device to request an user authentication when the user ID and the password are input by a user, an image reading unit that reads an image data from an original document when the user authentication requested by the user-authentication requesting unit is approved by the authentication server device, and an image storing unit that stores the image data read by the image reading unit in the storage unit.

### BACKGROUND OF THE INVENTION

1. Field of the Invention

The present invention relates to an image-data management system, a network scanner device, and an image-data management method.

2. Description of the Related Art

The prevalence and spread of network such as local area network (LAN) in office environment has made popular sharing of a single device, such as a scanner device, connected to the network among a plurality of computers, also connected to the network.

Such a network scanner device is equipped with various functions that allow previewing an image data read by the scanner device, editing the preview image, sending the image data to the computers on the network, accepting password input, etc. Therefore, such a network scanner device usually comes with an input device such as a keyboard and an output device such as a display.

JP-A-5-204585 discloses a device that is obtained as a result of integrating a high-resolution display device better than a character display device, with the character display device, so that read image data such as a personal or company seal can be displayed.

JP-A-6-255211 discloses a printer device that is made to connect a display and a keyboard so as to enhance input operability of mode settings of the printer.

Among network scanners, an automatic document feeder (ADF) type scanner comes equipped with the functions of continuous automatic document feeding, continuous reading of both sides of a plurality of original documents, batch conversions of large volumes of original documents into image data (of file formats such as Portable Document Format (PDF), Joint Photographic Experts Group (JPEG), Tagged Image File Format (TIFF), MTIFF (multi TIFF)), etc., when the original documents are set in the ADF.

Network scanners are generally used for storing or transmitting image data over a network to computers, or for transmitting image data as attachments with e-mails, etc.

For example, Scan Station 100 produced by Eastman Kodak Company (http://wwwjp.kodak.co/JP/ja/business/products/network/scanStation100.shtml) is equipped with the functionality of transmitting scanned image data to file servers and computers connected to the network, or send the scanned image data as an attachment with e-mails.

However, the advantage of compactness of input and output devices of the network scanner generally clashes with the enhancement of input operability and display ability while using them. In other words, in conventional network scanners, when the input and output devices attached to the network scanner are made compact to enable flexibility in the place of installation of the network scanner, there is a tradeoff in the ease of operation of the input device and poor visibility on the display.

For example, as in the ADF type network scanner (such as the Scan Station 100), when the installation area of the scanner device is reduced to enable flexibility in the place of installation of the scanner device itself, by making the input and output devices compact, this leads to loss of convenience for the users, when they use the scanner device.

Specifically, when the display device disclosed in JP-A-5-204585 is integrated with the network scanner device, the compactness is lost due to integration.

As in the JP-A-5-204585, when the network scanner device is made connectable to the display and the keyboard, this will result in increased installation area.

The conventional network scanners however do not have adequate measures against image data leakage. In other words, the conventional network scanners do not have adequate security measures such as by restricting computers accessing the network scanner or to control transmitting image data to other computer over the network or sending image data as attachments with e-mails.

As a security measure against image data leakage, the Scan Station 100 described above disallows operation from other computers, defeating the very purpose of a network scanner.

### SUMMARY OF THE INVENTION

It is an object of the present invention to at least partially solve the problems in the conventional technology.

An image-data management system according to one aspect of the present invention, includes an authentication server device and a network scanner connected to each other via a network, wherein the network scanner device includes a keyboard, a display, a control unit, and a storage unit, the keyboard and the display are disposed so as to cover the top of the body of the network scanner device. The control unit includes a user-authentication requesting unit that sends a user ID and password to the authentication server device to request an user authentication when the user ID and the password are input by a user, an image reading unit that reads an image data from an original document when the user authentication requested by the user-authentication requesting unit is approved by the authentication server device, and an image storing unit that stores the image data read by the image reading unit in the storage unit.

A network scanner device according to another aspect of the present invention includes an authentication server device connected to each other via a network, wherein the network scanner device includes a keyboard, a display, a control unit, and a storage unit, the keyboard and the display are disposed so as to cover the top of the body of the network scanner device. The control unit includes a user-authentication requesting unit that sends a user ID and password to the authentication server device to request an user authentication when the user ID and the password are input by a user, an image reading unit that reads an image data from an original document when the user authentication requested by the user-authentication requesting unit is approved by the authentication server device, and an image storing unit that stores the image data read by the image reading unit in the storage unit.

An image-data management method according to still another aspect of the present invention is executed by a network scanner device that includes an authentication server device connected to each other via a network, wherein the network scanner device includes a keyboard, a display, a control unit, and a storage unit, the keyboard and the display are disposed so as to cover the top of the body of the network scanner device. The method includes a user-authentication requesting step of sending a user ID and password to the authentication server device to request an user authentication when the user ID and the password are input by a user, an image reading step of reading an image data from an original document when the user authentication requested by the user-authentication requesting unit is approved by the authentication server device, and an image storing step of storing the image data read at the image reading step in the storage unit. The steps are executed by the control unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart indicating the basic principle of the present invention;

FIG. 2 is a block diagram of an image-data management system that implements the present invention;

FIG. 3 is a drawing of a scanner device 100 according to an embodiment of the present invention;

FIG. 4 is an explanation drawing of the scanner device 100 showing a display 114 covering an ADF cover;

FIG. 5 is a schematic of an opening and closing mechanism of the ADF cover;

FIGS. 6A and 6B are schematics for explaining the action of the opening and closing mechanism of the ADF cover;

FIG. 7 is a schematic for explaining the action of the opening and closing mechanism of the ADF cover;

FIG. 8 is a schematic for explaining a keyboard popping mechanism;

FIG. 9 is a schematic for explaining the keyboard popping mechanism;

FIG. 10 is a block diagram of a logical structure of a network scanner device 100 that implements the present invention;

FIG. 11 is a flowchart of showing the example of processes performed by the image-data management system according to the embodiment;

FIG. 12 is a screen transition drawing that shows the example of the transition of display screens presented to the user by the network scanner device 100;

FIG. 13 is a flowchart of showing the example of a transmission process performed when a user selects the transmission process to a mail server device 400;

FIG. 14 is a flowchart of showing the example of the transmission process performed when the user selects the transmission process to a fax server device 500;

FIG. 15 is a flowchart of the transmission process performed when the user selects the transmission process to a network-shared folder device 700;

FIG. 16 is a drawing of a Login screen;

FIG. 17 is a drawing of a Main menu screen;

FIG. 18 is a drawing of a Send e-mail screen;

FIG. 19 is a drawing of a Save screen;

FIG. 20 is a drawing of a Folder list screen;

FIG. 21 is a drawing of a Folder server authentication screen;

FIG. 22 is a drawing of a Scan settings screen;

FIG. 23 is a drawing of a Color mode screen;

FIG. 25 is a drawing of a Scan viewer screen;

FIG. 26 is a drawing of a Sending screen;

FIG. 27 is a table showing various functions in an associated form with information as to whether which user has the authority to perform settings of those functions;

FIG. 28 is a drawing of a Web setup login screen;

FIG. 29 is a drawing of an IP address setup screen;

FIG. 30 is a drawing of a Data backup/restore screen; and

FIG. 31 is a drawing of a Save in screen.

### DETAILED DESCRIPTION OF THE PREFERRED EMBODIMENTS

Exemplary embodiments of the image-data management system, the network scanner device, and the image-data management method according to the present invention are described below in detail with reference to the accompanying drawings. The present embodiment is not limited to the embodiments described herein.

### OVERVIEW OF THE INVENTION

An overview of the present invention is described first, followed by detail description of its structure and its processes.

The present invention relates to an image-data management system that includes at least an authentication server device and a network scanner device connected over a network, and the network scanner device belonging to the image-data management system. The network scanner device according to the present invention includes at least a keyboard, a display, a control unit, and a storage unit, wherein the keyboard and the display are disposed so as to cover the top of the body of the network scanner device. The display can be an extended graphics array (XGA) display unit of resolutions of equal to or more than 1024×768 pixels, and the keyboard can be a full keyboard. The network scanner device can be an automatic document feeder (ADF) type or a flatbed (FB) type network scanner device. The physical configuration of the network scanner device is described later.

“Full keyboard” refers to a keyboard having character input keys, each of which is assigned a single character such as alphabet. For example, there are 101, 104, 106, 107, 109, 112, or 113 keys on a full keyboard stipulated in Japanese Industrial Standard (JIS) or other standard. The keyboard can also include a numerical keypad. The display preferably has a display area of equal to or more than 8.4 inches. The display can include a touch panel.

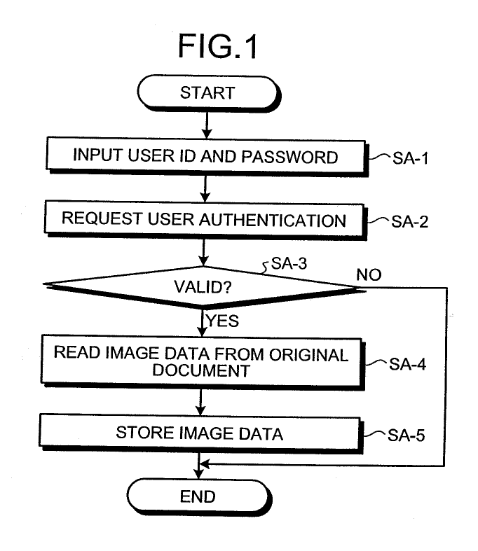

As shown in FIG. 1, when a user inputs a user ID and password (step SA-1), the network scanner device according to the present invention, sends the user ID and password to the authentication server device, and requests for user authentication (step SA-2).

When the authentication server device authenticates the user ID and password (Yes at step SA-3), the network scanner device reads the image data from the original document (step SA-4).

The network scanner device then stores the scanned image data in the storage unit (step SA-5). The network scanner device can be configured to encode the scanned image data before storing. The network scanner device can also be configured to affix to the scanned image data an index or keyword that can be used for document management.

The image-data management system according to the present invention can also be configured to include at least a mail server device, a fax server device, a print server device, or a network-shared folder device, also connected via the network.

In the above configuration, when the user authentication is approved by the authentication server device, the network scanner device will send the image data stored in the storage unit over the network to the mail server device or the fax server device or the print server device or the network-shared folder device, whichever is connected

The network scanner device can be configured to request the user to input the user settings when reading the image data, and request the authentication server device to store the user settings.

The network scanner device can be configured to receive update data from a management PC device and perform updation.

The network scanner device can be configured to send an error notification to the mail address of the user or an administrator when error is encountered in the network scanner device.

The network scanner device exerts control to show on the display a screen that would enable the user to select various processes such as user authentication request process, image reading process, network transmission process, user settings registration process, image data encoding process, document management process, update data reception process, and error notification sending process. When the user selects the process, the network scanner device can be configured to exert control to show on the display the various processes as a parallel process before the selected process is completed. In this case, the display screen can be created as Web contents.

### Configuration of the Image-Data Management System

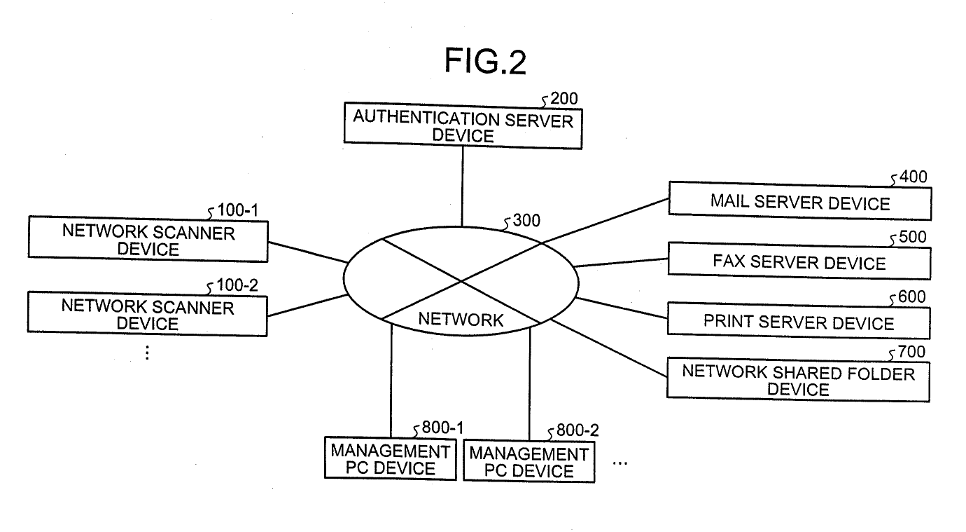

A configuration of the image-data management system according to the embodiment is described below with reference to FIG. 2. The image-data management system includes a network scanner device 100, an authentication server device 200 that provides directory database or directory service, a mail server device 400, a fax server device 500, a print server device 600, a server device such as a network-shared folder device 700, a management personal computer (PC) device 800, all of which are interconnected by a network 300. The image-data management system can have a plurality of network scanner devices 100 or management PC devices 800.

The network 300 connects the network scanner device 100, the authentication server device 200, the mail server device 400, and the management PC device 800 with one another, and can be the Internet or an intranet like a local area network (LAN) or a telephone line network.

The authentication server device 200 is connected to the network scanner device 100 via the network 300, and is equipped with a function of executing the directory database and the directory service in response to a request from the user or the administrator. The authentication server device 200 can, for example, be a lightweight directory access protocol (LDAP) server.

The term directory service refers to a system that stores the attributes (organization, domain, etc.) of resources (users, computers, etc.) connected to the network and allows the attributes to be searched, and performs management of the network resources by user authentication. In the present embodiment, the use of directory service such as Active Directory (product name) by Microsoft (company name) is preferable.

The mail server device 400 is connected to the network scanner device 100 via the network 300, and sends and receives e-mails of authenticated users. The mail server device 400 is configured by any combination of serves such as simple mail transfer protocol (SMTP) servers, post office protocol (POP) 3 servers, and Internet message access protocol (IMAP) 4 servers. The mail server device 400 can combine the functions of a domain name server (DNS) and a Windows (registered trademark) Internet name service (WINS).

The fax server device 500 is connected to the network scanner device 100 via the network 300, and sends and receives facsimiles of authenticated users.

The print server device 600 is connected to the network scanner device 100 via the network 300, and temporarily stores and prints the image data of authenticated users.

The network-shared folder device 700 is connected to the network scanner device 100 via the network 300, and stores the image data of authenticated users in predetermined folders.

The authentication server device 200, the mail server device 400, the fax server device 500, the print server device 600, and the network-shared folder device 700 can also be configured as Web servers or active server pages (ASP) servers, and can have a hardware configuration of commonly available data processing device such as work station and personal computer. All the functions of the server devices mentioned above are implemented by the hardware elements of the server devices such as central processing unit (CPU), disk device, memory device, input device, output device, and communication control device and the programs controlling these hardware elements.

The management PC device 800 performs maintenance and management of the network scanner device 100 by remote operation via the network 300. For example, the management PC device 800 sends update data to the network scanner device 100 via the network 300 and controls the network scanner device 100 to perform updation. The management PC device 800 is a commonly available data processing device such as personal computer, and exerts control to display user interface (for example, Web contents) provided by the network scanner device 100. The functions of the management PC device 800 are implemented by its hardware elements such as the CPU, disk device, memory device, input device, output device, and communication control device and the programs controlling these hardware elements.

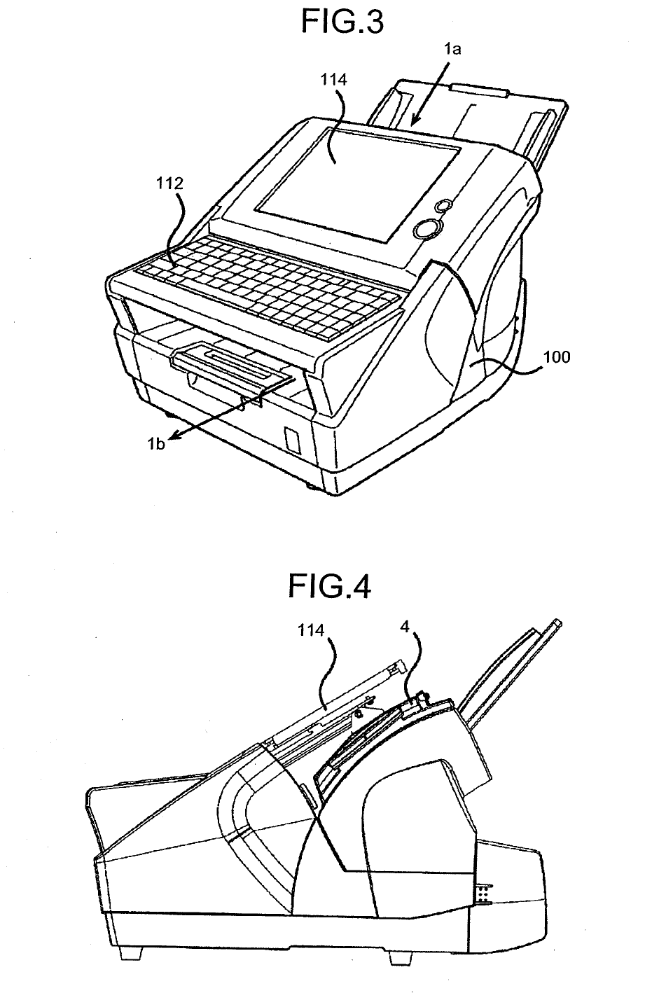

The network scanner device 100 is connected to the authentication server device 200, the mail server device 400, and the management PC device 800 via the network 300, and is equipped with an image reading function. The network scanner device 100 is an automatic document feeder (ADF) type device and includes at least a keyboard, a display, a control unit, and a storage unit, with the keyboard and the display covering the top of the body of the network scanner device. The display has resolutions of equal to or more than 1024×768 pixels, and the keyboard is a full keyboard. A detailed physical structure of the network scanner device 100 is described below with reference to FIGS. 3 to 9.

As shown in FIG. 3, the top of the body of the network scanner device 100 is covered by the display 114 and a keyboard 112. The display 114 can be equipped with a touch panel as shown in FIG. 3.

Placing the display 114 and the keyboard 112 so as cover the top of the body of the network scanner device 100 enables a large display and a full keyboard to be provided without having to increase the installation area of the network scanner device 100, and ensures user convenience.

The network scanner device 100 is configured in such a way that the display 114 covers the top of a sheet feeding unit 1a and the keyboard 112 covers the top of a sheet discharging unit 1b. However, this structure would pose a problem should there be jamming of sheet necessitating manual operation of the sheet feeding unit 1a or the sheet discharging unit 1b. As a solution to the problem, the network scanner device 100 includes a shaft provided towards the front of the body and that extends horizontally. The shaft allows the display 114 and the keyboard 112 to be rotated at fixed angles. The shaft is explained below in detail with reference to FIGS. 4 to 9.

When the sheet gets jammed during sheet feeding, an ADF cover 4 needs to be opened to free the jammed sheet. As shown in FIG. 4, as the display 114 covers the area above the sheet feeding unit 1a, the display 114 needs to be pulled up to be able to open the ADF cover 4. Similarly, the ADF cover 4 will need to be closed before pushing down the display 114 to its original position. Thus, removal of a jammed sheet would entail a whole lot of opening and closing.

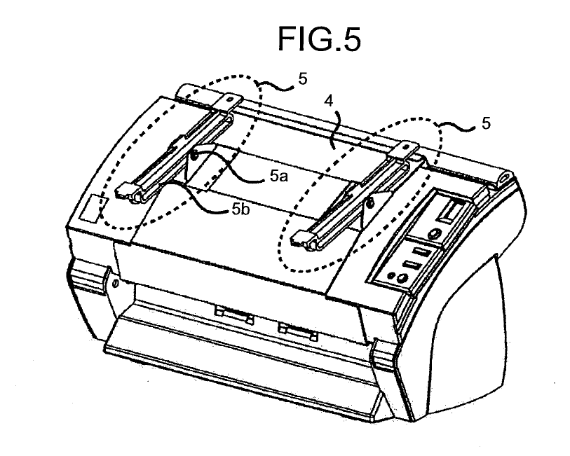

As shown in FIG. 5, the network scanner device 100 includes an ADF cover opening and closing mechanism 5 on the backside of the display 114. In other words, the ADF cover opening and closing mechanism 5 includes a guide rail 5b that fastens the backside of the display 114, and an ADF cover fixture 5a that fastens the upside of the ADF cover 4, and these are interlocked so as to be slidable in the rail direction of to the guide rail 5b.

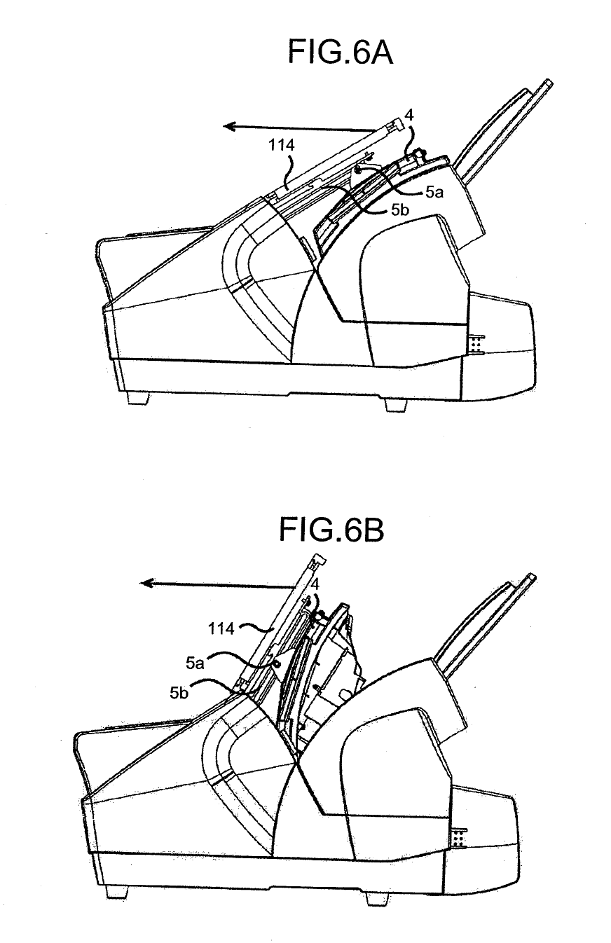

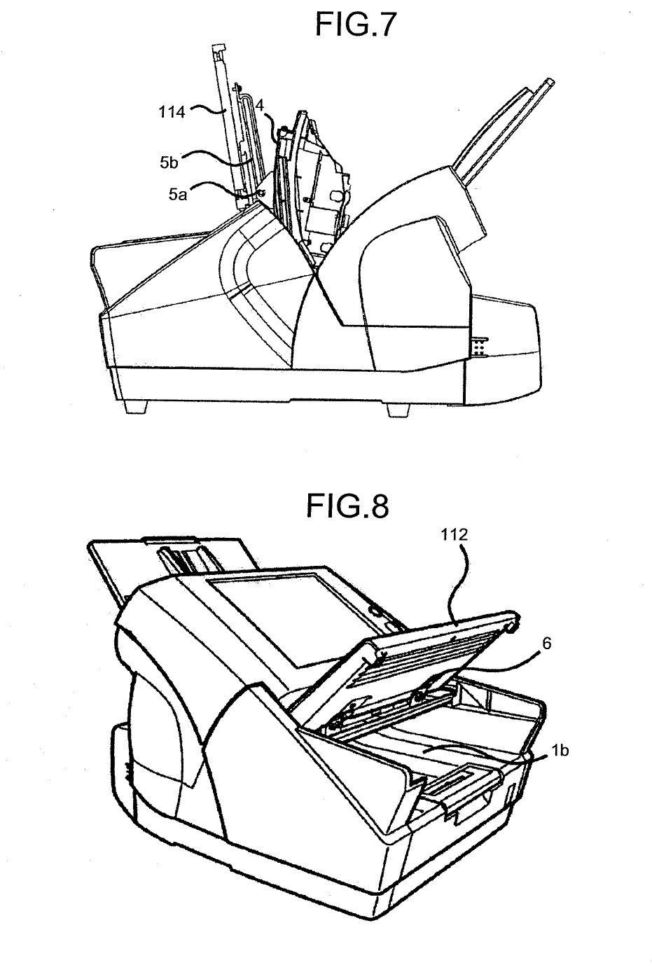

Thus, when the user pulls up the display 114 in the direction of the arrow shown in FIG. 6A, the ADF cover 4 also gets pulled up along with the display 114 because of the ADF cover opening and closing mechanism 5 that interlinks the backside of the display 114 and the ADF cover 4 shown in FIG. 6B. An interlocking member of the ADF cover fixture 5a that interlocks with the guide rail 5b moving smoothly along the rail, resolves any physical conflict arising due to the rotation shaft of the display 114 and the rotation shaft of the ADF cover 4 not matching. In other words, the user needs only to pull up the display 114 to have the ADF cover 4 completely open as shown in FIG. 7.

Thus, the ADF cover opening and closing mechanism 5 facilitates opening or closing of the ADF cover 4 by a user action of pulling up or pushing down of the display 114. Consequently, when the inside of the scanner device 100 has to be accessed for maintenance such as when a sheet gets jammed, it can be easily accomplished by just pulling up the display 114.

Original documents, after being scanned, are ejected into the sheet discharging unit 1b. However, when credit cards or visiting cards that are small in size, it would be difficult to retrieve them from the sheet discharging unit 1b because it has the keyboard 112 over it.

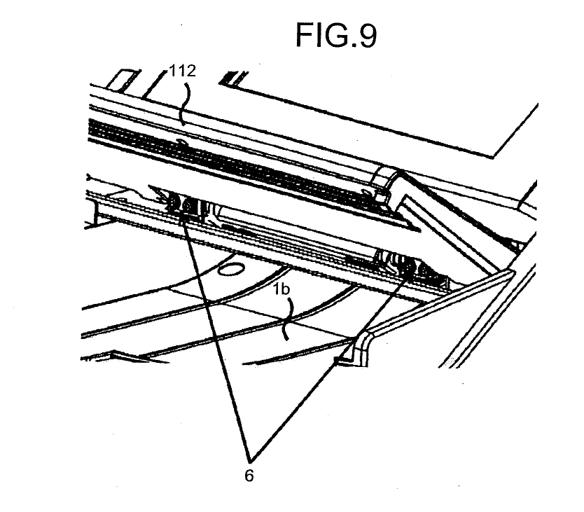

Therefore, as shown in FIG. 8, at the portion where the rear edge of the keyboard 112 is attached to the body of the scanner device, the network scanner device 100 is provided with a shaft that serves as a rotation support. This allows the keyboard 112 to be lifted up from the front edge. As shown in FIGS. 8 and 9, a flip-up mechanism 6 provided adjacent to the rotation shaft serves to assist the user to lift up the keyboard with less force, facilitating easy access for maintenance purposes.

Thus, when small size original documents such as credit cards and visiting cards after being scanned are ejected into the sheet discharging unit 1b beneath the keyboard 112, the user can be easily retrieved by lifting up the keyboard 112.

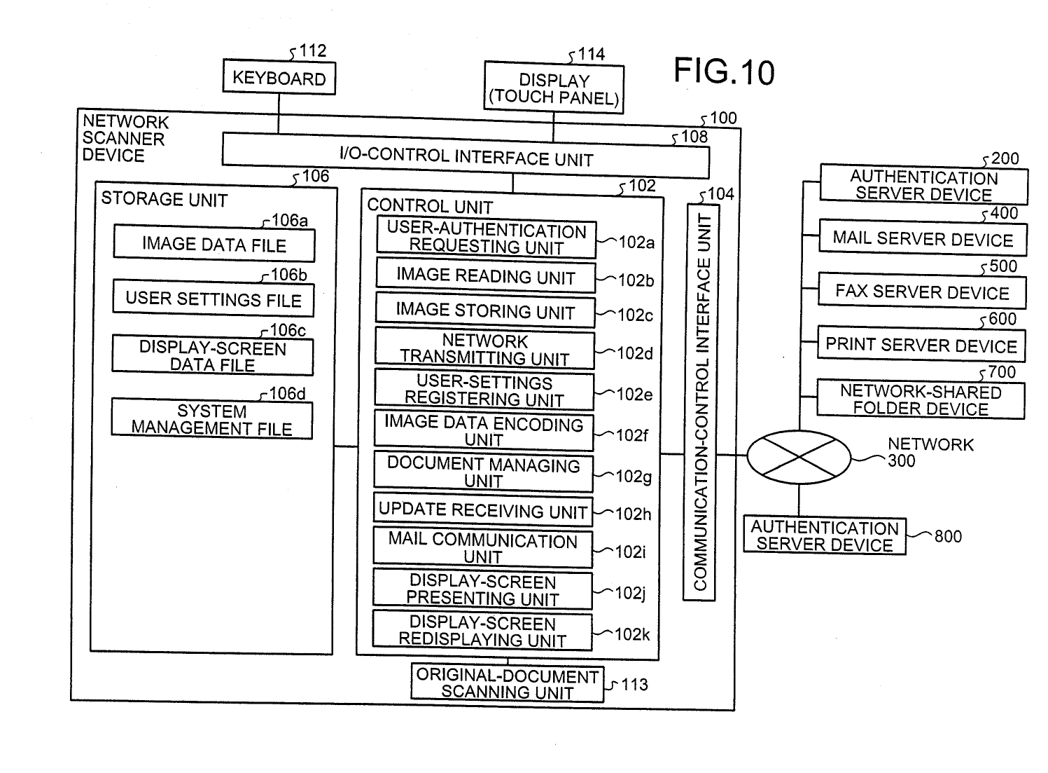

A logical structure of the network scanner device 100 is described below with reference to FIG. 10. Only parts relevant to the present invention are shown schematically in FIG. 10.

As shown in FIG. 10, The network scanner device 100 includes the control unit 102 that controls the CPU that centrally controls the network scanner device 100, a communication control interface unit 104 that connects the scanner device to a communication device (not shown) such as a router connected to a communication channel, an input/output (I/O) control interface unit 108 that connected to the keyboard 112 and the display 114, an original document scanning unit 113, and the storage unit 106 that stores therein various databases and tables. The control unit 102, the communication control interface unit 104, the I/O control interface unit 108, and the storage unit are communicably connected to one another by some communication channel. The network scanner device 100 is communicably connected to the network 300 by a communication device such as a router and by a wireless communication channel or a dedicated hard-wired communication channel.

The storage unit 106 is a fixed disk device and stores therein various databases and tables (image data file 106a, user settings file 106b, display-screen data file 106c, system management file 106d), and store for example, various programs, tables, files, databases, and web pages required for various processes.

The image data file 106a stored in the storage unit 106 is an image data storage unit storing therein image data.

The user settings file 106b is a user settings storage unit storing therein user settings. User settings include mail address, fax number, telephone number, etc. of the user other than settings pertaining to image scanning.

The display-screen data file 106c is a display screen data storage unit storing therein display screen data required by the administrator or the user for selecting various process. The display screen data can be Web contents data such as hypertext markup language (HTML) documents.

The system management file 106d is a system management data storage unit storing therein system management data such as computer programs and data required by each functional element of the control unit 102 to perform their respective functions. The control unit 102 of the scanner device 100 functions as each of the function element by reading the system management data stored in the system management file 106d.

The communication control interface unit 104 controls communication between the network scanner device 100 and the network 300 (or any communication device like a router) In other words, the communication control interface unit 104 helps the network scanner device 100 exchange data with another terminal via a communication channel.

The I/O control interface unit 108 controls the keyboard 112 and the display 114. The keyboard in the present embodiment is a full keyboard, such as there are 101, 104, 106, 107, 109, 112, or 113 keys on a full keyboard stipulated in Japanese Industrial Standard (JIS) or other standards. The keyboard 112 can also include a numerical keypad. The display 114 has a display screen having resolutions of equal to or more than 1024×768 pixels (extended graphics array (XGA)). The display 114 should preferably have a display area of equal to or more than 8.4 inches. The display 114 can include a touch panel.

The original-document scanning unit 113 is controlled by the control unit 102 to read the image from the original document, and includes all the mechanisms from the sheet feeding unit 1a to the sheet discharging unit 1b.

The control unit 102 includes an internal memory for storing control programs such as the operating system (OS), computer programs and data required for implementing process procedures, and performs data processing for implementing various processes through the computer programs. The control unit 102 functionally and conceptually includes a user-authentication requesting unit 102a, an image reading unit 102b, an image storing unit 102c, a network transmitting unit 102d, a user-settings registering unit 102e, an image-data encoding unit 102f, a document managing unit 102g, an updates receiving unit 102h, a mail notifying unit 102i, a display-screen presenting unit 102j, and a display-screen redisplaying unit 102k.

When the user inputs the user ID and password, the user-authentication requesting unit 102a controls the communication-control interface unit 104 to send the user ID and password to the authentication server device 200 via the network 300, requesting user authentication.

The image reading unit 102b controls the original-document scanning unit 113 to read the image data from the original document when the user authentication requested by the user-authentication requesting unit 102a is approved by the authentication server device 200.

The image storing unit 102c stores the image data read by the image reading unit 102b in the image data file 106a.

The network transmitting unit 102d controls the communication-control interface unit 104 to transmit the image data stored in the image data file 106a via the network 300 to the mail server device 400 or the fax server device 500 or the print server device 600 or the network-shared folder device 700 when the user authentication requested by the user-authentication requesting unit 102a is approved by the authentication server device 200.

The user-settings registering unit 102e exerts control so as to enable the user to input user settings to be applied when the image reading unit 102b reads the image data, stores the user settings in the user settings file 106b, controls the communication-control interface unit 104 to send the user settings via the network 300 to the authentication server device 200 to be stored therein. To exert control so as to enable the user to input user settings, the user-settings registering unit 102e can control the display screen being displayed based on the display screen data stored in the display-screen data file 106c.

The image-data encoding unit 102f encodes the image data read by the image reading unit 102b and stored in the image data file 106a.

The document managing unit 102g affixes to the image data read by the image reading unit 102b and stored in the image data file 106a an index or a keyword that can be used for document management.

The updates receiving unit 102h controls the communication-control interface unit 104 to receive the update data from the management PC device 800 via the network 300, stores the update data in the system management file 106d, and performs updation based on the update data. In other words, the updates receiving unit 102h adds the update data to the system management data such as computer programs and data or partially replaces the system management data stored in the system management file 106d with the update data, and performs updation when the network scanner device 100 is next started by causing the control unit 102 to read the updated system management data.

The mail notifying unit 102i sends to the mail address of the authenticated user or the administrator an error notification when error is encountered by the original-document scanning unit 113, or a completion notification when the task is completed without any error.

The display-screen presenting unit 102j refers to the display-screen data file 106c and presents the display screen so that the user can select any of the processes performed by the user-authentication requesting unit 102a, the image reading unit 102b, the image storing unit 102c, the network transmitting unit 102d, the user-settings registering unit 102e, the image-data encoding unit 102f, the document managing unit 102g, the updates receiving unit 102h, and the mail notifying unit 102i. The display-screen presenting unit 102j can also be configured to refer to the display-screen data file 106c and present the display screen data corresponding to the process selected by the user. The display-screen presenting unit 102j can also be configured to create Web contents as display screen, and to control the communication-control interface unit 104 to present the Web page to the management PC device 800 via the network 300.

The display-screen redisplaying unit 102k controls the display-screen presenting unit 102j to present the display screen once again before the completion of the process selected in the previously presented display screen.

### Process of the Image-Data Management System

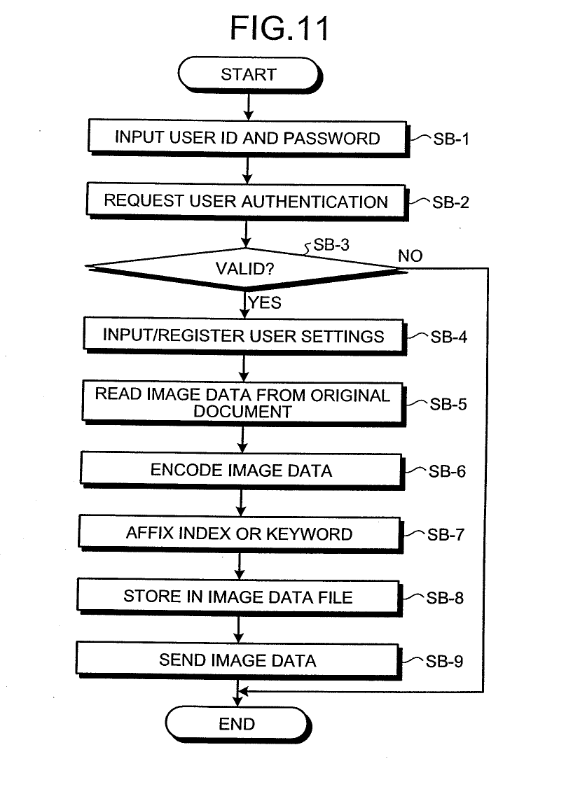

The processes performed by the image-data management system according to the embodiment are described below in detail with reference to FIG. 11.

The display-screen presenting unit 102j of the network scanner device 100 presents the display screen so as to enable the user to input the user ID and password (step SB-1). For example, the display-screen presenting unit 102j presents the display screen based on the display screen data stored in the display-screen data file 106c, enabling the user to input the user ID and password.

When the user inputs the user ID and password, the user-authentication requesting unit 102a of the network scanner device 100 controls the communication-control interface unit 104 to send the user ID and password to the authentication server device 200 via the network 300, requesting user authentication (step SB-2). Based on the received user ID and password, the authentication server device 200 refers to the directory database to check whether the administrator has granted permission to the user to use the network scanner device 100, and sends back the outcome of user authentication to the network scanner device 100. The authentication server device 200 can be configured to send to the network scanner device 100 the settings and mail address stored in the directory service along with the outcome of user authentication.

When the authentication request is approved by the authentication server device 200 (Yes at step SB-3), the user-settings registering unit 102e of the network scanner device 100 exerts control so as to enable the user can input user settings to be applied when the image reading unit 102b reads the image data. For example, to exert control so as to enable the user to input user settings, the user-settings registering unit 102e controls the display screen being presented to the user based on the display screen data stored in the display-screen data file 106c. The user-settings registering unit 102e controls the communication-control interface unit 104 to send the user settings via the network 300 to the authentication server device 200 to be stored therein (step SB-4). The authentication server device 200 stores the user settings received from the user-settings registering unit 102e in an associated form with the corresponding user ID in the directory database.

The image reading unit 102b of the network scanner device 100 controls the original-document scanning unit 113 to read the image data from the original document (step SB-5). The image reading unit 102b can perform the user settings (such as Color/Black and White, resolution) for the image reading process based on the user settings stored in the user settings file 106b.

The image-data encoding unit 102f of the network scanner device 100 encodes the image data read by the image reading unit 102b (step SB-6).

The document managing unit 102g of the network scanner device 100 affixes to the image data an index or a keyword that can be used for document management (step SB-7).

The image storing unit 102c of the network scanner device 100 stores the image data in the image data file 106a (step SB-8).

The network transmitting unit 102d of the network scanner device 100 controls the communication-control interface unit 104 to send the image data stored in the image data file 106a via the network 300 to the mail server device 400 or the fax server device 500 or the print server device 600 or the network-shared folder device 700 when the user authentication requested by the user-authentication requesting unit 102a is approved by the authentication server device 200 (step SB-9). The network transmitting unit 102d can be configured to individually determine, based on the user authentication data received from the authentication server device 200, the scope of the network resources (the network scanner device 100, the mail server device 400, the fax server device 500, the print server device 600, and the network-shared folder device 700) granted permission to use the network scanner device by the administrator.

The updates receiving unit 102h of the network scanner device 100 can be configured to control the communication-control interface unit 104 to receive the update data from the management PC device 800 via the network 300, stores the update data in the system management file 106d, and perform updation based on the update data. In other words, the updates receiving unit 102h can be configured to add the update data to the system management data such as computer programs and data or partially replace the system management data stored in the system management file 106d with the update data, and perform updation when the network scanner device 100 is next started by causing the control unit 102 to read the updated system management data.

The mail notifying unit 102i of the network scanner device 100 can be configured to send to the mail address of the authenticated user or the administrator an error notification when error is encountered by the original-document scanning unit 113, or a completion notification when the task is completed without any error.

The display-screen presenting unit 102j of the network scanner device 100 can be configured to present the display screen (such as web contents) so that the user can select any of the processes performed by the user-authentication requesting unit 102a, the image reading unit 102b, the image storing unit 102c, the network transmitting unit 102d, the user-settings registering unit 102e, the image-data encoding unit 102f, the document managing unit 102g, the updates receiving unit 102h, and the mail notifying unit 102i. In this case, the display-screen redisplaying unit 102k can be configured to control the display-screen presenting unit 102j to present the display screen once again before the completion of the process selected in the previously presented display screen.

### Example of the Present Embodiment

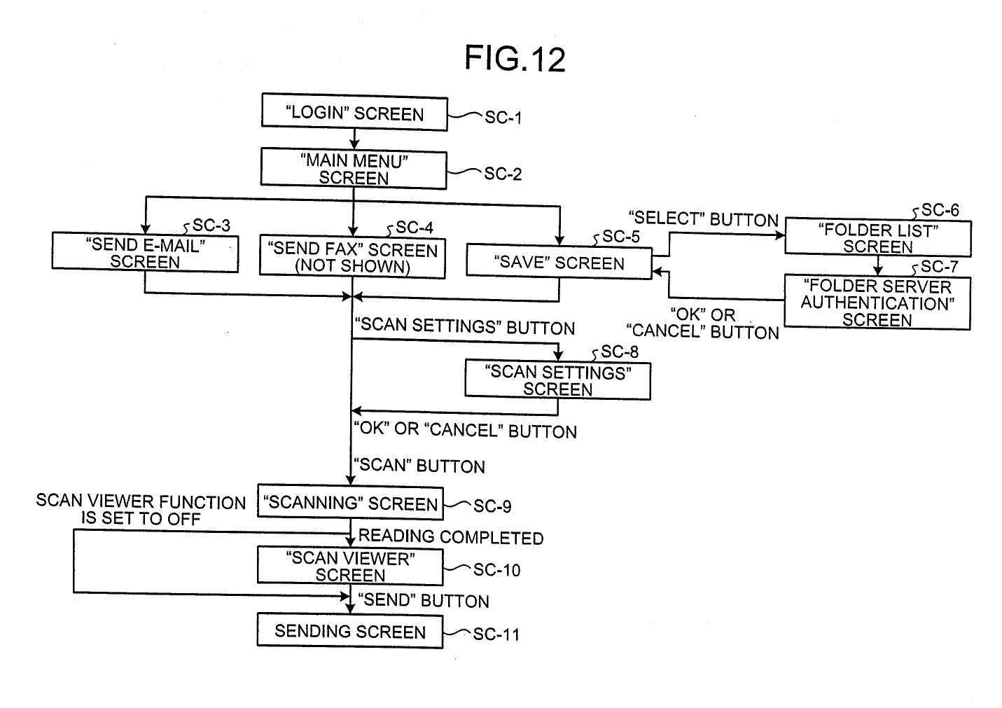

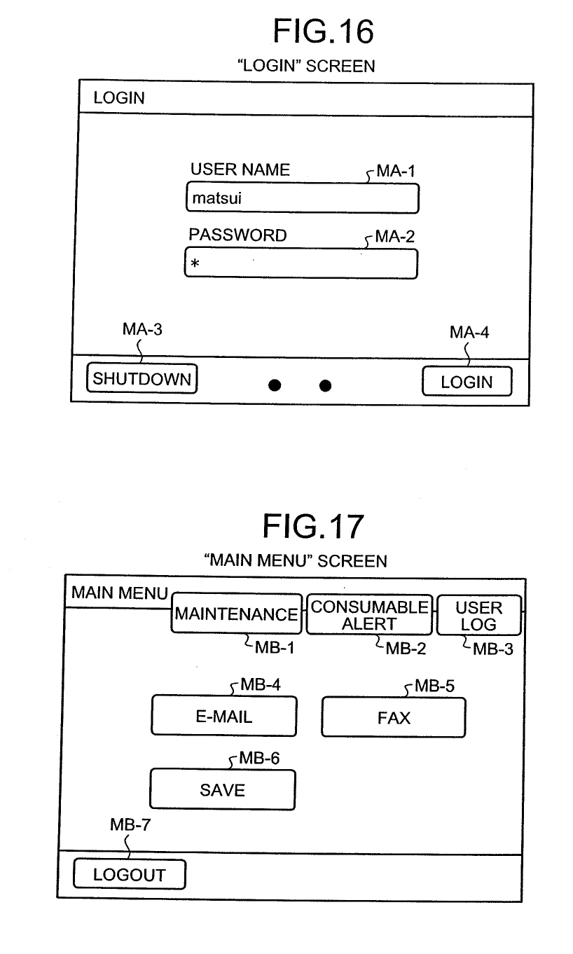

A working example of the present embodiment is described below with reference to FIGS. 12 to 31. FIG. 12 is a screen transition drawing that shows the transition of display screens presented to the user by the network scanner device 100. Each of the screens shown in FIG. 12 will be explained in detail with reference to FIGS. 16 to 26 by providing sample screens (which are partially shown).

As shown in FIG. 12, the display-screen presenting unit 102j presents to the user a Login screen (see FIG. 16) enabling the user to input user ID and password (step SC-1). In other words, the display-screen presenting unit 102j displays the Login screen based on the display screen data corresponding to the Login screen stored in the display-screen data file 106c (all the screens described hereinafter are presented in a similar fashion and hence the same description applies to them as well).

When the authentication requested by user-authentication requesting unit 102a to the authentication server device 200 is approved, the display-screen presenting unit 102j presents to the user a Main menu screen (see FIG. 17) enabling the user to select one of the transmission processes (to the mail server device 400 or the fax server device 500 or the network-shared folder device 700) performed by the network transmitting unit 102d (step SC-2).

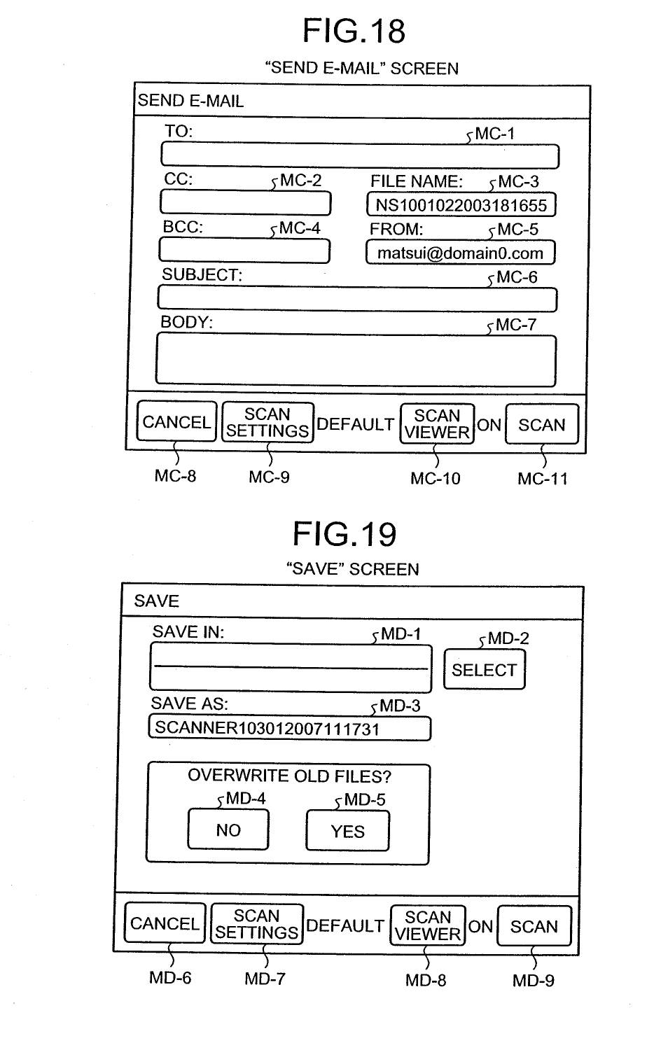

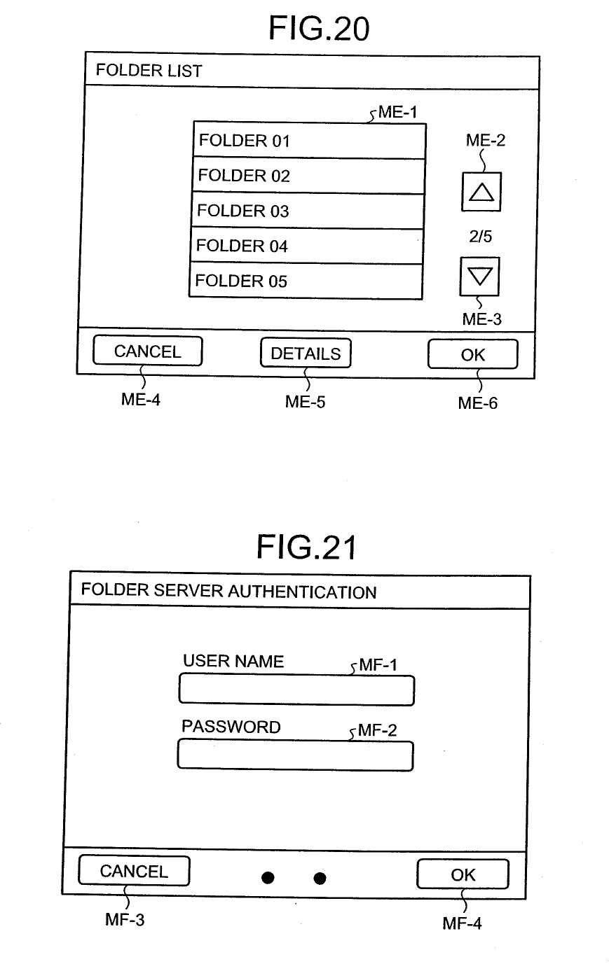

When the user selects the transmission process to the mail server device 400, the display-screen presenting unit 102j presents a Send e-mail screen (see FIG. 18) (step SC-3). When the user selects the transmission process to the fax server device 500, the display-screen presenting unit 102j presents a Send fax screen (not shown) (step SC-4). When the user selects the transmission process to the network-shared folder device 700, the display-screen presenting unit 102j presents a Save screen (see FIG. 19) (step SC-5). The display-screen presenting unit 102j can be configured to present a Folder list screen (see FIG. 20) (step SC-6) and further present a Folder server authentication screen (see FIG. 21) (step SC-7), when the user selects the transmission process to the network-shared folder device 700.

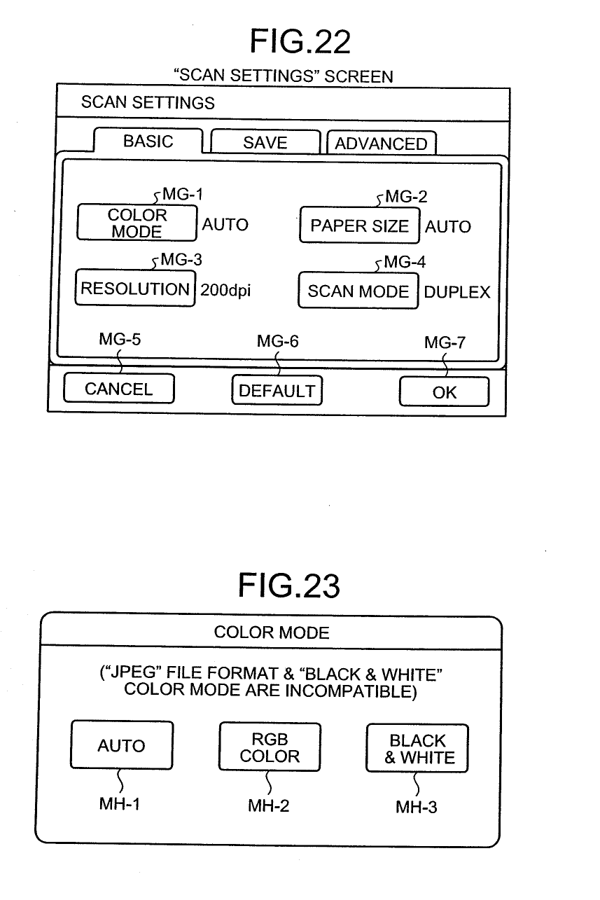

When the user presses the Scan settings button in the Send e-mail screen or Send fax screen or Save screen, the user-settings registering unit 102e presents a Scan settings screen (see FIG. 22) enabling the user to input user settings (step SC-8). When the user presses the OK button or Cancel button in the Scan settings screen, the display-screen presenting unit 102j reverts to the Send e-mail screen or Send fax screen or Save screen, as the case may be.

When the user presses the Scan button in the Send e-mail screen or Send fax screen or Save screen, the display-screen presenting unit 102j presents a Scanning screen (see FIG. 24), displaying the ongoing scanning process of the image data by the image reading unit 102b (step SC-9).

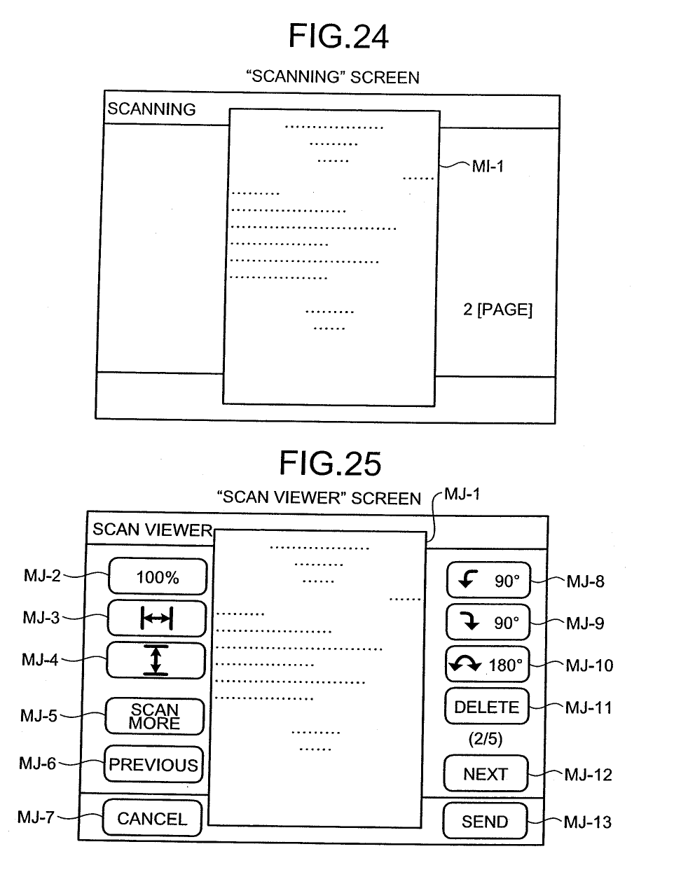

When the image reading unit 102b completes the scanning process of the image data, the display-screen presenting unit 102j displays a Scan viewer screen (see FIG. 25) that displays the scanned image data (step SC-10). When the Scan viewer function is set to Off, the display-screen presenting unit 102j proceeds to step SC-11 without presenting the Scan viewer screen.

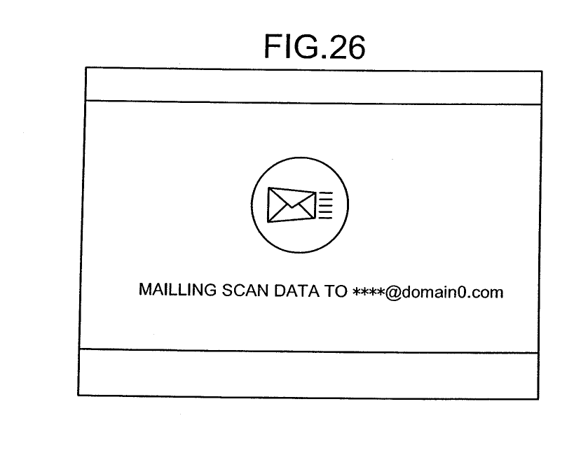

When the user presses the Send button in the Scan viewer screen, the network transmitting unit 102d implements the transmission process selected by the user and the display-screen presenting unit 102j presents to the user a Sending screen (see FIG. 26) (step SC-11), ending the display screen transition process by the display-screen presenting unit 102j and the user-settings registering unit 102e.

### Process Flow of Each of the Transmission Processes

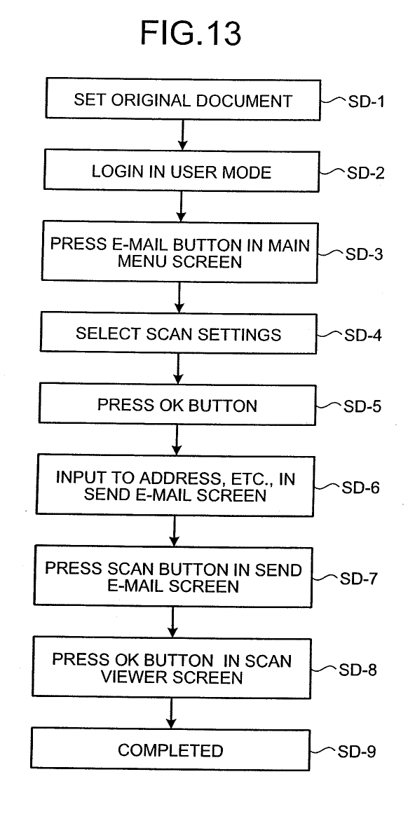

Process flow when the user selects the each of the transmission processes is described below with reference to FIGS. 13 to 26.

### Process Flow of Transmission Process to the Mail Server Device

The process flow when the user selects the transmission process to the mail server device 400 is described with reference to FIG. 13 and FIGS. 16 to 26.

As shown in FIG. 13, when the user sets the original document in the original-document scanning unit 113 (step SD-1), the display-screen presenting unit 102j presents the Login screen shown in FIG. 16.

As shown in FIG. 13, the Login screen includes the fields User name MA-1 and Password MA-2, which are a user ID input area and is a password input area, respectively, a Shutdown button MA-3, and a Login button MA-4.

When the user presses the Login button MA-4 after entering the user ID in the field User name MA-1 and the password in the field Password MA-2 (step SD-2), the user-authentication requesting unit 102a sends the user ID and password to the authentication server device 200 via the network 300, requesting user authentication.

When the authentication request is approved by the authentication server device 200, the display-screen presenting unit 102j presents the Main menu screen shown in FIG. 17.

The Main menu screen includes a Maintenance button MB-1, a Consumables alert button MB-2, a User log button MB-3, an e-mail button MB-4, a Fax button MB-5, a Save button MB-6, and a Logout button MB-7.

When the user presses the e-mail button MB-4 (step SD-3), the display-screen presenting unit 102j, presents the Send e-mail screen shown in FIG. 18.

The Send e-mail screen includes fields To MC-1, Cc MC-2, File name MC-3, Bcc MC-4, From MC-5, Subject MC-6, Body MC-7, and a Cancel button MC-8, a Scan settings button MC-9, a Scan viewer function selection button MC-10, and a Scan button MC-11.

When the user presses the Scan settings button MC-9, the user-settings registering unit 102e presents the Scan settings screen shown in FIG. 22 (step SD-4).

The Scan settings screen includes a Color mode button MG-1 (for selecting color mode or Black and White mode), a Paper size button MG-2 (for selecting auto-mode or setting-mode), a Resolution button MG-3 (for example, 200 dpi), a Scan mode button MG-4 (for selecting simplex scanning or duplex scanning), a Cancel button MG-5, a Default button MG-6, and an OK button MG-7. When the user selects the Color mode button MG-1, the user-settings registering unit 102e presents a Color mode screen shown in FIG. 23.

The Color mode screen includes an Auto button MH-1, an RGB color button MH-2, and a Black and white button MH-3.

Thus, the user-settings registering unit 102e presents the display screen enabling the user to select desired setting. After selecting the settings, when the user presses the OK button MG-7 (step SD-5), the user-settings registering unit 102e sends, using a lightweight direction access protocol (LADP), the setting values (user settings) to the authentication server device 200, requesting the user settings to be stored for each function (the mail transmission function, the fax transmission function, the save function) in an associated form with the user. The authentication server device 200 stores the user settings in the directory database in an associated form with the user ID, and sends the user settings along with the user authentication outcome to the network scanner device 100 when the user next logs in. The user-settings registering unit 102e stores the user settings in the user settings file 106b, enabling the image reading unit 102b to present to the user during the next login the display screen with the same setting values as those during the user's previous login.

When the user presses the Cancel button MG-5 or the OK button MG-7 in the Scan settings screen, the display-screen presenting unit 102j, reverts to the Send e-mail screen shown in FIG. 18.

When after inputting the destination mail address in the field To MC-1, a subject in the field Subject MC-6, and the text in the field Body MC-7 (step SD-6), the user presses the Scan button MC-11 (step SD-7), the image reading unit 102b starts reading the image data, and the display-screen presenting unit 102j presents the Scanning screen shown in FIG. 24, displaying the ongoing scanning process of the image data.

When reading is completed by the image reading unit 102b, the display-screen presenting unit 102j presents the Scan viewer screen shown in FIG. 25.

The Scan viewer screen includes a preview area MJ-1, a Show actual size button MJ-2, a Fit horizontally button MJ-3, a Fit vertically button MJ-4, a Scan more button MJ-5, a Show previous screen button MJ-6, a Cancel button MJ-7, a Rotate 90° counter-clockwise button MJ-8, a Rotate 90° clockwise button MJ-9, a Rotate 180° button MJ-10, a Delete button MJ-11, a Show next screen button MJ-12, and a Send button MJ-13.

When the user presses the Scan more button MJ-5, the image reading unit 102b starts reading another image data. When the user presses any of the Rotate buttons MJ-8 to MJ-10, the control unit 102 rotates the image data by the specified angle. When the user presses the Delete button MJ-11, the control unit 102 deletes the image data being displayed in the preview area MJ-1. When the user presses the Show actual size button MJ-2, the display-screen presenting unit 102j displays the image data in its actual size. When the user presses the Fit horizontally button MJ-3, the display-screen presenting unit 102j fits the image data horizontally in the preview area MJ-1. When the user presses the Fit vertically button MJ-4, the display-screen presenting unit 102j fits the image data vertically in the preview area MJ-1.

When the user presses the Send button MJ-13 (step SD-8), the network transmitting unit 102d sends the mail with the image data as an attachment to the mail server device 400 via the network 300, and the display-screen presenting unit 102j presents the Send e-mail screen shown in FIG. 26, thus ending the process (step SD-9). The mail notifying unit 102i sends to the mail address of the authenticated user or the administrator an error notification when error is encountered by the network scanner device 100, or a completion notification when the task is completed without any error.

### Process Flow of Transmission Process to the Fax Server Device

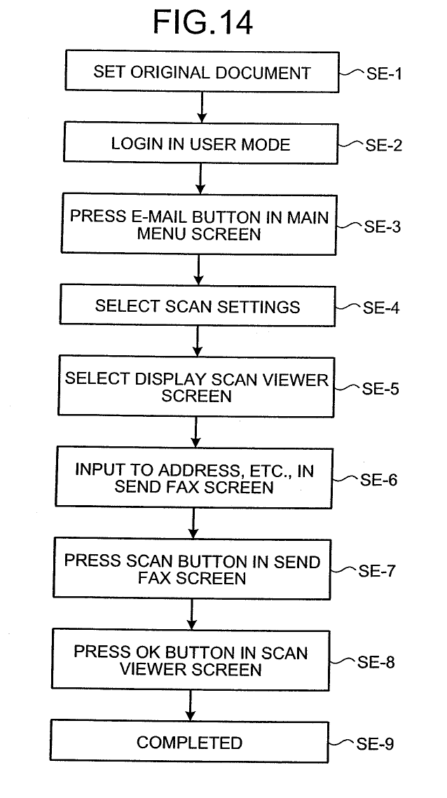

The process flow when the user selects the transmission process to the fax server device 500 is described with reference to FIG. 14.

Steps SE-1 to SE-9 in FIG. 14 correspond respectively to steps SD-1 to SD-9 in FIG. 13 with the exception of step SE-6 at which the display-screen presenting unit 102j presents to the user the Send fax screen enabling the user to input the destination fax number, etc.

### Process Flow of Transmission Process to the Network-Shared Folder Device

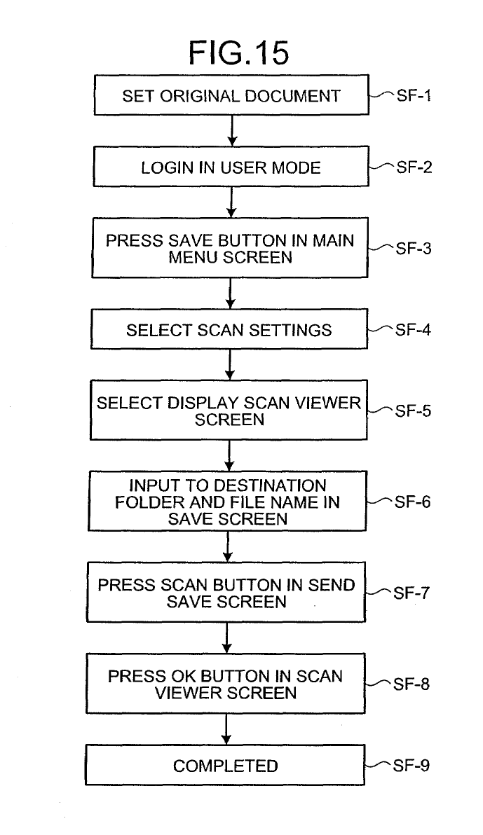

The process flow when the user selects the transmission process to the network-shared folder device 700 is described with reference to FIG. 15 and FIGS. 19 to 21.

Steps SF-1 to SF-9 in FIG. 15 correspond respectively to steps SD-1 to SD-9 in FIG. 13 with the exception of step SF-6 at which the display-screen presenting unit 102j presents to the user the Save screen shown in FIG. 19 enabling the user to specify the destination folder and file name.

The Save screen includes the fields Save in MD-1 for inputting a save destination input area and Save as MD-3 for inputting the file name for the image data, a Select button MD-2, which is a save destination selection button, an area for specifying Yes or No to overwriting old files with a No button MD-4 and a Yes button MD-5, a Cancel button MD-6, a Scan settings button MD-7, a Scan viewer button MD-8 for selecting the scan viewer function, and a Scan button MD-9.

When the user presses the Select button MD-2, the display-screen presenting unit 102j presents the Folder list screen shown in FIG. 20. The Folder list screen includes an destination folder selection area ME-1 that lists the folders to be specified as the destination folder, an up arrow button ME-2, a down arrow button ME-3, a Cancel button ME-4, a Default button ME-5, and an OK button ME-6.

When after selecting a destination folder in the destination folder selection area ME-1 the user presses the OK button ME-6, the display-screen presenting unit 102j presents the Folder server authentication screen shown in FIG. 21, provided the settings required for authorizing accessing the network-shared folder device 700 are in place. The Folder server authentication screen includes fields User name MF-1 and Password MF-2, a Cancel button MF-3, and an OK button MF-4.

When the user inputs the user ID and password in the fields User name MF-1 and Password MF-2, respectively, and presses the OK button MF-4, the user-authentication requesting unit 102a sends the user ID and password to the authentication server device 200 via the network 300, requesting user authentication. When the user ID and password are valid, the authentication server device 200 allows the user to send the image data to the network-shared folder device 700.

### User Authority

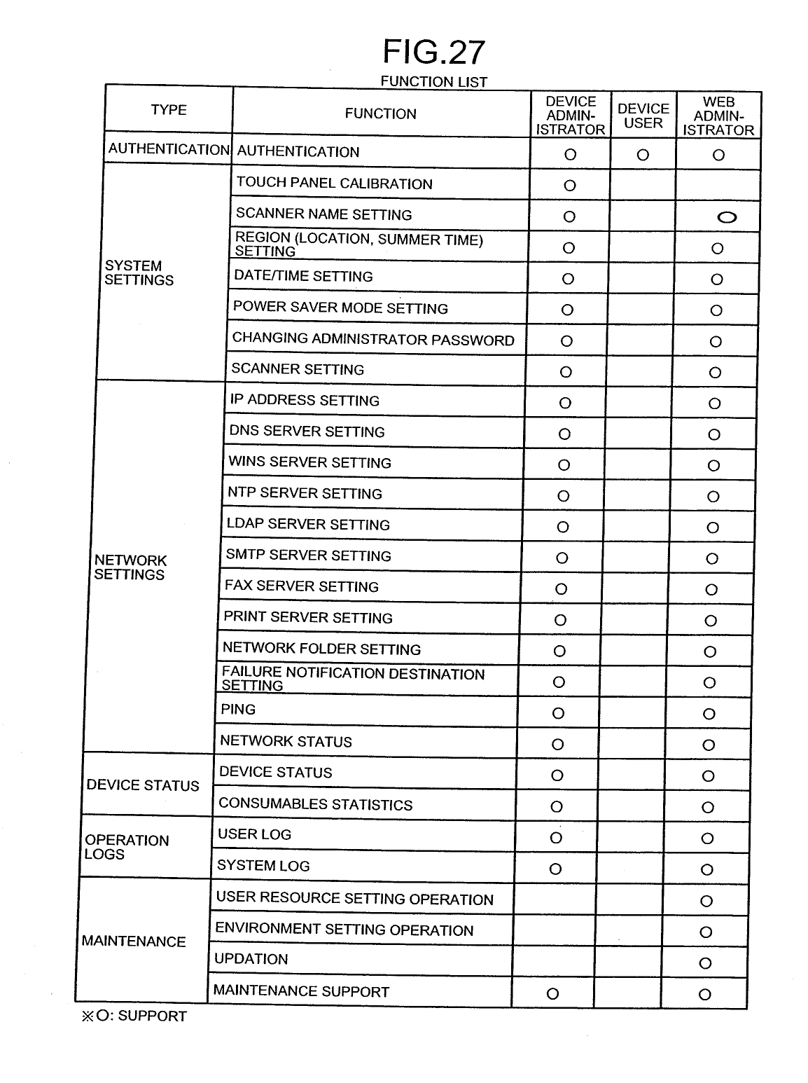

Level of authority granted to the various users for setting the functions of the network scanner device 100 is described with reference to FIGS. 27 to 31.

Generally, the administrator, the user, and the Web administrator possess authority to set the various functions of the network scanner device 100. The level of authority is granted by the directory service implemented by the network scanner device 100 or the authentication server device 200.

As shown in FIG. 27, the administrator has authority to perform environment setup and management of the network scanner device 100 by directly operating it, to operate the network scanner device 100 to scan and send image data, and to operate the network scanner device 100 from a remote device such as the management PC device 800 and perform environment setting and management.

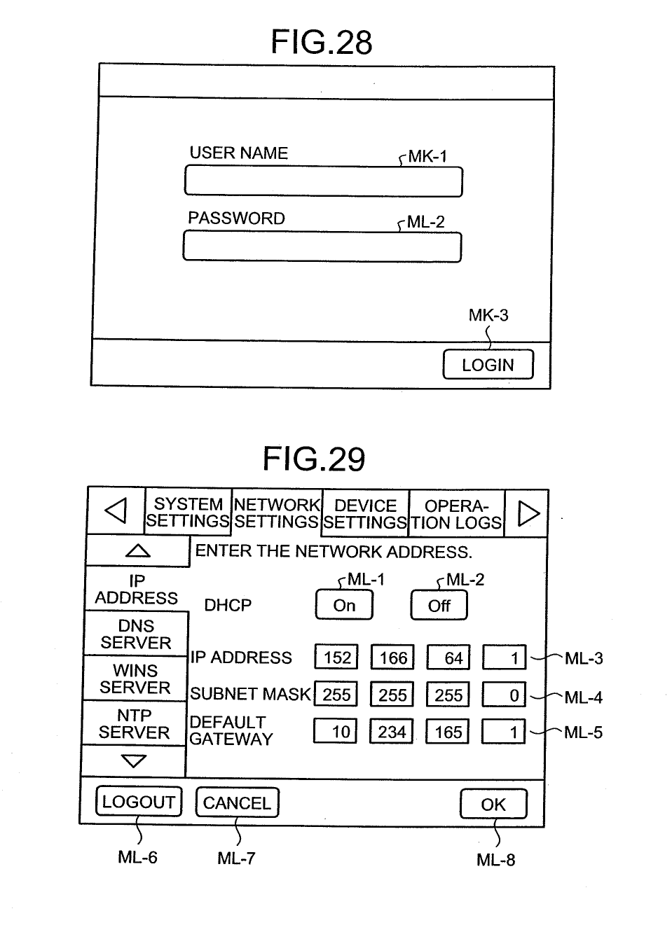

Thus, security measures can be taken against data leak by granting authority to only specified users. The process procedure of Internet protocol (IP) address setup performed as network setup by the administrator is described next with reference to FIGS. 28 to 31.

The Web setup login screen includes the fields User name MK-1, which is a user ID input area, and Password MK-2, which is a password input area, and a Login button MK-3.

When the administrator inputs the user ID and password in the fields User name MK-1 and Password MK-2, respectively, and presses the Login button MK-3, the user-authentication requesting unit 102a sends the user ID and password to the authentication server device 200 via the network 300, requesting user authentication.

When the user ID and password are valid, the display-screen presenting unit 102j presents to the administrator the IP address setup screen shown in FIG. 29. The IP address setup screen includes a dynamic host configuration protocol (DHCP) On button ML-1 and a DHCP Off button ML-2, the fields IP address ML-3, Subnet mask ML-4, Default gateway ML-5, a Logout button ML-6, a Cancel button ML-7, and an OK button ML-8.

When the administrator presses the OK button ML-8 after entering the values in the fields, the control unit 102 registers the settings.

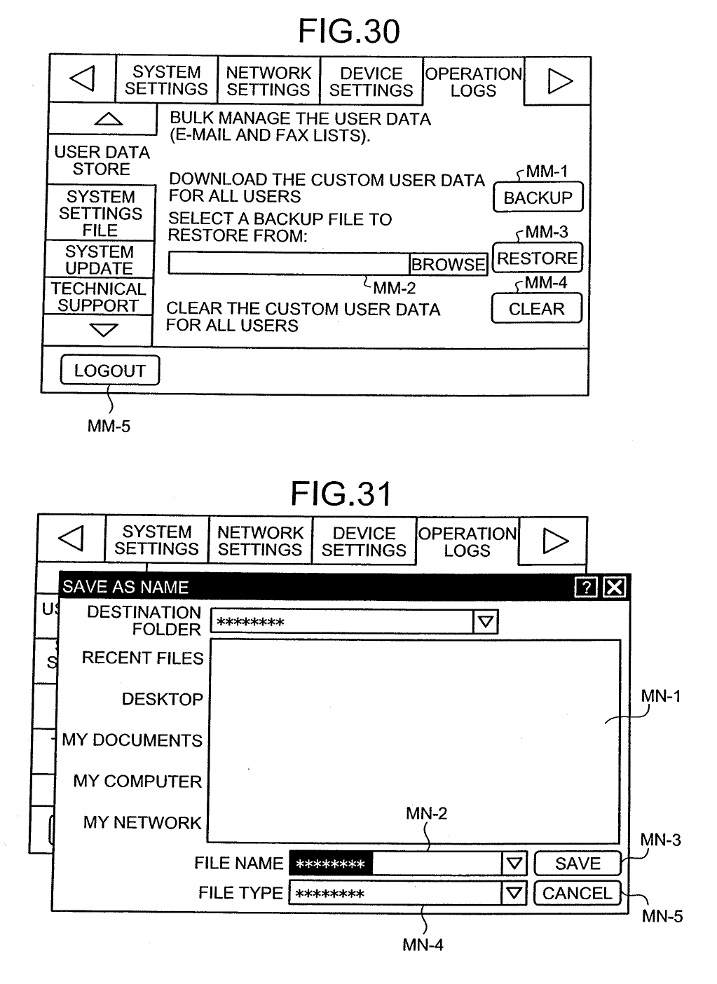

The process procedure of data backup and restoration of the user settings performed by the administrator is described next with reference to FIGS. 30 and 31.

The Data backup/restore screen includes a Backup button MM-1, a Select a backup file to restore from field MM-2, a Restore button MM-3, a Clear button MM-4, and a Logout button MM-5.

When the administrator presses the Backup button MM-1, the display-screen presenting unit 102j presents to the administrator the Save in screen.

The Save in screen includes a destination file list display area MN-1, the fields File name MN-2 and File type MN-4, a Save button MN-3, and a Cancel button MN-5.

When the administrator presses the Save button MN-3 after selecting the destination folder from the destination folder list display area MN-1 and entering the values in the fields File name MN-1 and File type MN-4, the control unit 102 saves the user settings of all the users in the specified file.

When the administrator presses the Restore button MM-3 after specifying a file in the Select a backup file to restore from field, the control unit 102 restores the saved user data.

### Other Embodiments

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

A network scanner device is presented as an example for explaining the present invention. However, the present invention can be applied to any device that has a display and a keyboard.

In the embodiment, the network scanner device 100 performs various processes a stand-alone device. However, the network scanner device 100 can be configured to perform processes in response to request from the management PC device 800, which is a separate unit, and return the process results to the management PC device 800.

All the automatic processes explained in the present embodiment can be, entirely or in part, carried out manually. Similarly, all the manual processes explained in the present embodiment can be, entirely or in part, carried out automatically by a known method.

The process procedures, the control procedures, specific names, data, including various parameters such as search conditions, display example, and database construction, mentioned in the description and drawings can be changed as required unless otherwise specified.

The constituent elements of the network scanner device 100 are merely conceptual and may not necessarily physically resemble the structures shown in the drawings. For instance, the apparatus need not necessarily have the structure that is illustrated.

For example, the process functions performed by the apparatus can be entirely or partially realized by a central processing unit (CPU) or a computer program executed by the CPU or by a hardware using wired logic. The computer program, recorded on a recording medium, can be mechanically read by the network scanner device 100 as the situation demands. In other words, the computer program recorded on the recording medium can cause the storage unit 106 such as read-only memory (ROM) or hard disk (HD) to work in coordination with the operating system (OS) to issue commands to the CPU and cause the CPU to perform various processes. The computer program is first loaded to the random access memory (RAM), and forms a control unit in collaboration with the CPU.

Alternatively, the computer program can be stored in any application program server connected to the network scanner device 100 via the network 300, and can be fully or partially loaded as the situation demands.

The computer-readable recording medium on which the computer program can be stored may be a portable type such as flexible disk, magneto optic (MO) disk, ROM, erasable programmable ROM (EPROM), electrically erasable programmable ROM (EEPROM), compact disk-read-only memory (CD-ROM), digital versatile disk (DVD), or a communication medium that stores the computer program for a short term such as communication channels or carrier waves that transmit the computer program over networks such as local area network (LAN), wide area network (WAN), and the Internet.

Computer program refers to a data processing method written in any computer language and can have software codes and binary codes in any format. The computer program can be a dispersed form in the form of a plurality of modules or libraries, or can perform various functions in collaboration with a different program such as the OS. Any known configuration in the scanner device according to the embodiment can be used for reading the recording medium. Similarly, any known process procedure for reading or installing the computer program can be used.

The storage unit 106 is a fixed disk device such as RAM, ROM, and hard disk or flexible disk, optical disk, and stores therein various programs, databases (image data file 106a, user settings file 106b, display-screen data file 106c, system management file 106d), tables, and web pages required for various processes and opening websites.

The network scanner device 100 can also be connected to any existing personal computer, workstation, etc. and can be operated by executing software (that includes computer program, data, etc.) that implements the method according to the present invention in the personal computer or workstation.

The distribution and integration of the device are not limited to those illustrated in the figures. The device as a whole or in parts can be functionally or physically distributed or integrated in an arbitrary unit according to various attachments or how the device is to be used.

According to the present invention, the compactness of the network scanner device allows it to be installed anywhere. In addition, image processing and file management of the image data read by the network scanner device can be carried out without compromised ease of operation and good visibility of displayed data on the display device. In other words, the network scanner device according to the present invention achieves space-saving while being equipped with an input device in the form of a keyboard and an output device in the form of a large screen.

According to the present invention, in spite the network scanner device being equipped with remote operation function and various kinds of transmission functions, adequate security against leakage of image data is ensured.

According to the present invention, only users with authentication can make use of the functions such as sending mail or fax, printing, and saving in shared folder. Consequently, the administrator can manage the user authorization with ease.

According to the present invention, user settings are stored in the directory database in the authorization server device. Consequently, personal information of the user such as mail address is kept confidential. In addition, whenever the user next operates the network scanner device, the user settings are invoked, enhancing the user-friendliness of the network scanner device.

According to the present invention, the image date is encoded. Consequently, relatively large image data can be compressed, enabling it to be encrypted while sending via the network, thus enhancing security.

According to the present invention, index or keywords can be affixed to the image data, rendering the image data compatible with document management software, making it useful for approval or forms control.

According to the present invention, the network scanner device is updatable. Consequently, when there are new security-related issues, they can be easily addressed.

According to the present invention, the user or the administrator is notified of any error encountered or of successful completion of task. Consequently, in case of occurrences such as paper jamming, the concerned user is notified. Similarly, when a task is successfully completed, the concerned user is notified.

According to the present invention, a display with a display area of equal to or more than 8.4 inches is provided. Consequently, a cost-effective scanner device with a satisfactory quality of display can be obtained as compared to a scanner device having a poor quality 6.5 inch video graphics array (VGA) display.

According to the present invention, a touch panel is provided in the display, providing the user with a further improved operability.

According to the present invention, the network scanner device presents the user with a user interface while performing a user-selected process in the background. Thus, the need for the user to wait for a process to end in order to perform the next operation is obviated.

According to the present invention, the user interface is presented as Web contents, enabling the network scanner device to be operated from a remote device such as another management PC device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. An image-data management system comprising an authentication server device and a network scanner connected to each other via a network, wherein
the network scanner device includes a keyboard, a display, a control unit, and a storage unit, the keyboard and the display are disposed so as to cover the top of the body of the network scanner device, and
the control unit includes:
a user-authentication requesting unit that sends a user ID and password to the authentication server device to request an user authentication when the user ID and the password are input by a user;
an image reading unit that reads an image data from an original document when the user authentication requested by the user-authentication requesting unit is approved by the authentication server device; and
an image storing unit that stores the image data read by the image reading unit in the storage unit.

2. The image-data management system according to claim 1, further including at least one of a mail server device, a fax server device, a print server device, and a network-shared folder device connected via the network, wherein
the control unit further includes a network transmitting unit that sends the image data stored in the storage unit via the network to the mail server device, the fax server device, the print server device, and the network-shared folder device, when the user authentication requested by the user-authentication requesting unit is approved by the authentication server device.

3. The image-data management system according to claim 1, wherein
the control unit further includes a user-settings registering unit that exerts control so as to enable the user to input user settings to be applied when the image reading unit reads the image data, and sends the user settings to the authentication server device to be stored therein.

4. The image-data management system according to claim 1, wherein
the control unit further includes an image-data encoding unit that encodes the image data read by the image reading unit.

5. The image-data management system according to claim 1, wherein
the control unit further includes a document managing unit that affixes to the image data read by the image data reading unit an index or a keyword to be used for document management.

6. The image-data management system according to claim 1, further including a management PC device connected via the network, wherein
the control unit includes an updates receiving unit that receives update data from the management PC device and performs updation.

7. The image-data management system according to claim 1, wherein
the control unit further includes a mail notifying unit that sends to a mail address of an authenticated user or an administrator an error notification when error is encountered by the network scanner device, or a completion notification when the task is completed without any error.

8. The image-data management system according to claim 1, wherein the display has resolutions of equal to or more than 1024×768 pixels, and the keyboard is a full keyboard.

9. The image-data management system according to claim 1, wherein the display has a display area of equal to or more than 8.4 inches.

10. The image-data management system according to claim 1, wherein the display includes a touch panel.

11. The image-data management system according to claim 1, wherein the control unit further includes
a display-screen presenting unit that presents a display screen on the display so as to enable the user to select for execution any of the user-authentication requesting unit, the image reading unit, the network transmitting unit, the user-settings registering unit, the image-data encoding unit, the document managing unit, the updates receiving unit, and the mail notifying unit, and
a display-screen redisplaying unit that, when the user selects the functional units, exerts control on the display-screen presenting unit to present the display screen on the display before the functional units selected by the user completes a process.

12. The image-date management system according to claim 11, wherein the display screen is created as Web contents.

13. A network scanner device comprising an authentication server device connected to each other via a network, wherein
the network scanner device includes a keyboard, a display, a control unit, and a storage unit, the keyboard and the display are disposed so as to cover the top of the body of the network scanner device, and
the control unit includes:
a user-authentication requesting unit that sends a user ID and password to the authentication server device to request an user authentication when the user ID and the password are input by a user;
an image reading unit that reads an image data from an original document when the user authentication requested by the user-authentication requesting unit is approved by the authentication server device; and
an image storing unit that stores the image data read by the image reading unit in the storage unit.

14. The network scanner device according to claim 13, further including at least one of a mail server device, a fax server device, a print server device, and a network-shared folder device connected via the network, wherein
the control unit further includes a network transmitting unit that sends the image data stored in the storage unit via the network to the mail server device, the fax server device, the print server device, and the network-shared folder device, when the user authentication requested by the user-authentication requesting unit is approved by the authentication server device.

15. The network scanner device according to claim 13, wherein
the control unit further includes a user-settings registering unit that exerts control so as to enable the user to input user settings to be applied when the image reading unit reads the image data, and sends the user settings to the authentication server device to be stored therein.

16. The network scanner device according to claim 13, wherein
the control unit further includes an image-data encoding unit that encodes the image data read by the image reading unit.

17. The network scanner device according to claim 13, wherein
the control unit further includes a document managing unit that affixes to the image data read by the image data reading unit an index or a keyword to be used for document management.

18. The network scanner device according to claim 13, further including a management PC device connected via the network, wherein
the control unit includes an updates receiving unit that receives update data from the management PC device and performs updation.

19. The network scanner device according to claim 13, wherein
the control unit further includes a mail notifying unit that sends to a mail address of an authenticated user or an administrator an error notification when error is encountered by the network scanner device, or a completion notification when the task is completed without any error.

20. The network scanner device according to claim 13, wherein the display has resolutions of equal to or more than 1024×768 pixels, and the keyboard is a full keyboard.

21. The network scanner device according to claim 13, wherein the display has a display area of equal to or more than 8.4 inches.

22. The network scanner device according to claim 13, wherein the display includes a touch panel.

23. The network scanner device according to claim 13, wherein the control unit further includes
a display-screen presenting unit that presents a display screen on the display so as to enable the user to select for execution any of the following functional units that are the user-authentication requesting unit, the image reading unit, the network transmitting unit, the user-settings registering unit, the image-data encoding unit, the document managing unit, the updates receiving unit, and the mail notifying unit, and
a display-screen redisplaying unit that, when the user selects the functional units, exerts control on the display-screen presenting unit to present the display screen on the display before the functional units selected by the user completes a process.

24. The network scanner device according to claim 23, wherein the display screen is created as Web contents.

25. An image-data management method executed by a network scanner device comprising an authentication server device connected to each other via a network, wherein
the network scanner device includes a keyboard, a display, a control unit, and a storage unit, the keyboard and the display are disposed so as to cover the top of the body of the network scanner device, and
the method comprises:
a user-authentication requesting step of sending a user ID and password to the authentication server device to request an user authentication when the user ID and the password are input by a user;
an image reading step of reading an image data from an original document when the user authentication requested by the user-authentication requesting unit is approved by the authentication server device; and
an image storing step of storing the image data read at the image reading step in the storage unit
wherein, the steps are executed by the control unit.
